(19) United States
(12) Patent Application Publication
(10) Pub. No.: US 2021/0060508 A1
(43) Pub. Date: Mar. 4, 2021

(54) REFORMED GAS CONSUMING PLANT AND SOURCE GAS REFORMING METHOD

(71) Applicant: MITSUBISHI HEAVY INDUSTRIES, LTD., Tokyo (JP)

(72) Inventors: Koichiro YOSHITOKU, Tokyo (JP); Yukio TANAKA, Tokyo (JP); Keiichi NAKAGAWA, Tokyo (JP)

(21) Appl. No.: 16/782,322

(22) Filed: Feb. 5, 2020

(30) Foreign Application Priority Data
Aug. 29, 2019 (JP) 2019-157038

(51) Int. Cl. B01J 8/00; C01B 3/38

(52) U.S. Cl. CPC B01J 8/008; C01B 3/384; B01J 8/001; C01B 2203/0238; B01J 2208/00389; C01B 2203/0811; C01B 2203/066; C01B 2203/1241; C01B 2203/0233

(57) ABSTRACT

A plant that consumes a reformed gas obtained by reforming a source gas including at least methane and carbon dioxide includes: a reforming device that includes a reforming catalyst for reforming the source gas and an electric power supply member for supplying electric power to the reforming catalyst and that supplies electric power to the reforming catalyst to reform the source gas; and a reformed gas consuming apparatus that consumes the reformed gas A reaction temperature of a reforming reaction of the source gas in the reforming device can be adjusted by adjusting a supply amount of a heating medium including exhaust heat generated due to consumption of the reformed gas in the reformed gas consuming apparatus to the reforming device when heat exchange between the source gas and the heat medium is performed in the reforming gas.

### TECHNICAL FIELD

The present disclosure relates to a plant that consumes a reformed gas and a method for reforming a source gas.

### BACKGROUND

Patent Document 1 discloses a plant that reforms a source gas such as a natural gas by steam reforming which uses steam and dry reforming which uses carbon dioxide to obtain a reformed gas including hydrogen and a carbon monoxide.

### CITATION LIST

### Patent Literature

Patent Document 1: WO2012/140994

### SUMMARY

However, steam reforming and dry reforming require a very high temperature of approximately 900° C. Since a heat source used for increasing the temperature such a high temperature is limited or it is necessary to manufacture or supply such a heat source additionally, there is a problem that the cost of an entire plant increases.

With the foregoing in view, an object of at least one embodiment of the present disclosure is to suppress increase in the cost of a reformed gas consuming plant and a source gas reforming method.

In order to attain the object, a plant according to the present disclosure is a plant that consumes a reformed gas obtained by reforming a source gas including at least methane and carbon dioxide, the plant comprising: a reforming device including a reforming catalyst for reforming the source gas and an electric power supply member for supplying electric power to the reforming catalyst, the reforming device being configured to supply electric power to the reforming catalyst to reform the source gas; and a reformed gas consuming apparatus configured to consume the reformed gas, wherein a reaction temperature of a reforming reaction of the source gas in the reforming device is adjustable by adjusting a supply amount of a heating medium to the reforming device when heat exchange between the source gas and the heat medium is performed in the reforming gas, the heat medium including exhaust heat generated due to consumption of the reformed gas in the reformed gas consuming apparatus.

A method according to the present disclosure is a method for reforming a source gas including at least methane and carbon dioxide, the method comprising: a reforming step of reforming the source gas by supplying electric power to a reforming catalyst for reforming the source gas; a consuming step of consuming the reformed gas; and an adjusting step of adjusting a reaction temperature of a reforming reaction of the source gas in the reforming step by adjusting a supply amount of a heating medium when heat exchange between the source gas and the heat medium is performed, the heat medium including exhaust heat generated due to consumption of the reformed gas.

According to the plant of the present disclosure, since a reforming catalyst is an electric field catalyst that supplies electric power to a reforming catalyst to reform a source gas, it is possible to decrease a reaction temperature of a reforming reaction of the source gas as compared to when an electric field catalyst is not used. As a result, since a reaction temperature of the reforming reaction of the source gas in the reforming device can be adjusted using a heating medium including the exhaust heat generated due to consumption of the reformed gas in the reformed gas consuming apparatus, it is possible to suppress increase in the cost of a plant that consumes the reformed gas.

### BRIEF DESCRIPTION OF DRAWINGS

FIG. 1 is a block diagram of a plant according to Embodiment 1 of the present disclosure.

FIG. 2 is a block diagram of a reforming device provided in the plant according to Embodiment 1 of the present disclosure.

FIG. 3 is a block diagram of a methanol synthesis apparatus provided in the plant according to Embodiment 1 of the present disclosure.

FIG. 4 is a block diagram of a portion of a modification of the plant according to Embodiment 1 of the present disclosure.

FIG. 5 is a block diagram of a plant according to Embodiment 2 of the present disclosure.

FIG. 6 is a block diagram of a plant according to Embodiment 3 of the present disclosure.

### DETAILED DESCRIPTION

Hereinafter, a plant according to an embodiment of the present disclosure will be described with reference to the drawings. The embodiment illustrates an aspect of the present disclosure and does not restrict the present disclosure and can be changed arbitrarily within the scope of the technical idea of the present disclosure.

### Embodiment 1

<Configuration of Plant According to Embodiment 1>

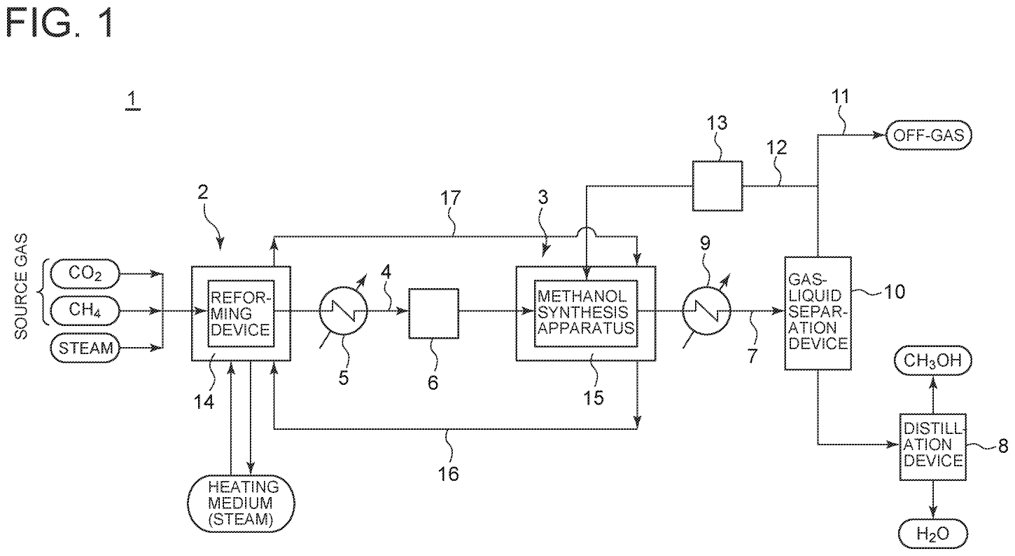

A plant according to Embodiment 1 of the present disclosure will be described by way of an example of a plant that manufactures methanol. As illustrated in FIG. 1, a plant 1 according to Embodiment 1 includes a reforming device 2 that reforms a source gas including at least methane and carbon dioxide and a methanol synthesis apparatus 3 that synthesizes methanol using a reformed gas obtained by the reforming device 2 as a raw material. Here, since the reformed gas is consumed in the methanol synthesis apparatus 3 in order to synthesize methanol, the methanol synthesis apparatus 3 forms a reformed gas consuming apparatus.

The reforming device 2 and the methanol synthesis apparatus 3 communicate with each other through a pipe 4, and a heat exchanger 5 for cooling a reformed gas and a compressor 6 for compressing the reformed gas and supplying the same to the methanol synthesis apparatus 3 are provided in the pipe 4. The methanol synthesis apparatus 3 communicates through a pipe 7 with a distillation device 8 that distillate an out-flowing fluid flowing out of the methanol synthesis apparatus 3. A heat exchanger 9 for cooling the out-flowing fluid flowing out of the methanol synthesis apparatus 3 and a gas-liquid separation device 10 that separates the out-flowing fluid cooled by the heat exchanger 9 into gas and liquid are provided in the pipe 7. An off-gas line 11 for emitting the separated gas as an off-gas is provided in the gas-liquid separation device 10. A recycle line 12 for supplying a portion of the separated gas to the methanol synthesis apparatus 3 before the gas is emitted as an off-gas is also provided. A compressor 13 is provided in the recycle line 12.

A heating medium circulation chamber 14 in which a heating medium for adjusting the temperature of a reforming reaction of a source gas circulates is provided in the reforming device 2. A cooling medium circulation chamber 15 in which a cooling medium for cooling the heat generated in the synthesis reaction of methanol which uses a reformed gas as a raw material circulates is provided in the methanol synthesis apparatus 3. The heating medium circulation chamber 14 and the cooling medium circulation chamber 15 communicate with each other through a heating medium circulation pipe 16 and a cooling medium circulation pipe 17. Although a configuration of the heating medium circulation chamber 14 and the cooling medium circulation chamber 15 is not limited particularly, an example of the configuration thereof will be described later.

In the reforming device 2, the source gas is reformed (that is, consumed) and a reformed gas including at least a carbon monoxide and hydrogen is obtained by both steam reforming in which methane and water (steam) react with each other as described in reaction formula (1) below and dry reforming in which methane and carbon dioxide react with each other as described in reaction formula (2) below.

CH₄+H₂O→CO+3H₂ (1)

CH₄+CO₂→2CO+2H₂ (2)

However, although the reaction formulas (1) and (2) are described so that only a forward reaction occurs, the reactions are equilibrium reactions in which a reverse reaction can actually occur.

<Configuration of Reforming Device 2>

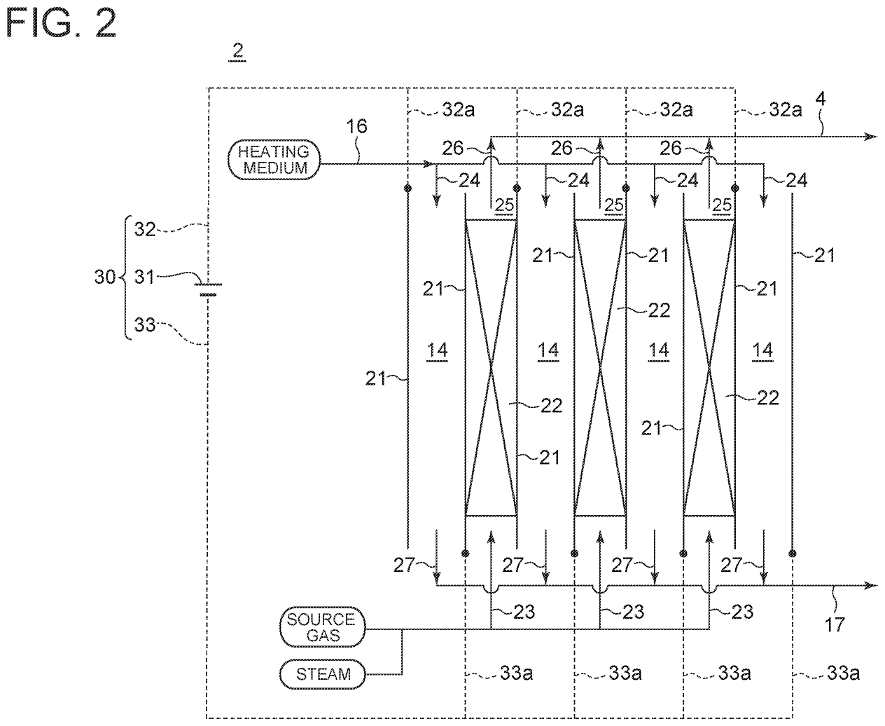

Although a configuration of the reforming device 2 is not limited particularly, an example of the configuration is schematically illustrated in FIG. 2. The reforming device 2 illustrated in FIG. 2 has the same configuration as a so-called plate-type heat exchanger. The reforming device 2 has a plurality of (at least three) plates 21 arranged in parallel. A plurality of spaces formed by adjacent plates 21 are arranged in parallel in the direction in which the plurality of plates 21, 21 are arranged in parallel. A reforming catalyst 22 for reforming a source gas is accommodated in the spaces alternately in the direction in which the plurality of spaces are arranged in parallel.

The spaces in which the reforming catalyst 22 is accommodated are configured to communicate with a source gas supply pipe 23 for supplying a source gas, and the spaces in which the reforming catalyst 22 is not accommodated are configured to communicate with a heating medium supply pipe 24 for supplying a heating medium. That is, the source gas circulation chamber 25 in which the reforming catalyst 22 is accommodated and a source gas circulates and the heating medium circulation chamber 14 in which a heating medium circulates are provided in the reforming device 2 so as to be arranged alternately in the direction in which the plurality of plates 21 are arranged in parallel. In Embodiment 1, steam for the steam reforming is supplied to the source gas circulation chambers 25 through the source gas supply pipe 23. Each of the heating medium supply pipes 24 branches off from the heating medium circulation pipe 16. Moreover, a reformed gas outlet pipe 26 through which the reformed gas flows out of the source gas circulation chambers 25 communicates with the source gas circulation chambers 25, and the reformed gas outlet pipes 26 are connected to a pipe 4. A cooling medium outlet pipe 27 through which the cooling medium generated when the heating medium is cooled by the operation to be described later flows out of the heating medium circulation chamber 14 communicates with the heating medium circulation chambers 14, and the cooling medium outlet pipes 27 are connected to a cooling medium circulation pipe 17.

An electric power supply member 30 that supplies electric power to the reforming catalyst 22 is provided in the reforming device 2. The electric power supply member 30 includes a DC power supply 31, a wire 32 having one end connected to a positive electrode of the DC power supply 31, and a wire 33 having one end connected to a negative electrode of the DC power supply 31. In this embodiment, although the wire 32 is connected to an inlet side of the heating medium and the wire 33 is connected to an inlet side of the source gas, the wire 32 may be connected to an inlet side of the source gas and the wire 33 may be connected to an inlet side of the heating medium. The other end side of the wire 32 branches into a plurality of branch wires 32a, and the branch wires 32a are connected to the plates 21 alternately in the direction in which the plurality of plates 21 are arranged in parallel. The other end side of the wire 33 branches into a plurality of branch wires 33a, and the branch wires 33a are connected to the plates 21 to which the branch wires 32a are not connected. That is, the branch wires 32a of the wire 32 and the branch wires 33a of the wire 33 are connected to the plates 21 so as to be arranged alternately in the direction in which the plurality of plates 21 are arranged in parallel. However, the configuration of the reforming device 2 is not limited to the same configuration as the plate-type heat exchanger, but an arbitrary configuration such as a cylindrical structure disclosed in Japanese Patent No. 6312494 may be employed.

For electric power to be supplied from the electric power supply member 30 to the reforming catalyst 22, a catalyst through which at least a current flows needs to be used as the reforming catalyst 22. A catalyst in which Pd is supported on CeO₂, a catalyst in which Pt is supported on CeO₂—ZrO₂, CeO₂—AlO₂, or CeO₂—SiO₂, a catalyst in which at least one of Ro, Ru, Pt, Ir, Pd, Ni, and Fe is supported on a carrier made from a material containing at least one of ceria, zirconia, and bismuth oxide, and other catalysts can be used as the reforming catalyst 22 for the steam reforming, for example. A catalyst in which at least one of Fe, Co, Ni, Cu, Pd, and Pt is supported on a carrier in which ZrO₂ is doped with a lanthanoid-based material (La, Ce, Pr, Nd, Y), and other catalysts can be used as the reforming catalyst 22 for the dry reforming, for example.

In the above-described configuration, the reforming catalyst 22 for the steam reforming and the reforming catalyst 22 for the dry reforming may be mixed and accommodated in each source gas circulation chamber 25 or the reforming catalysts 22 may be accommodated in a manner of being divided in the circulation direction of the source gas. In contrast, when the source gas circulation chamber 25 to which methane and carbon dioxide are supplied and the source gas circulation chamber 25 to which methane and steam are supplied are present, the reforming catalyst 22 for the steam reforming may be accommodated in the source gas circulation chamber 25 to which methane and steam are supplied, and the reforming catalyst 22 for the dry reforming may be accommodated in the source gas circulation chamber 25 to which methane and carbon dioxide are supplied.

<Configuration of Methanol Synthesis Apparatus 3>

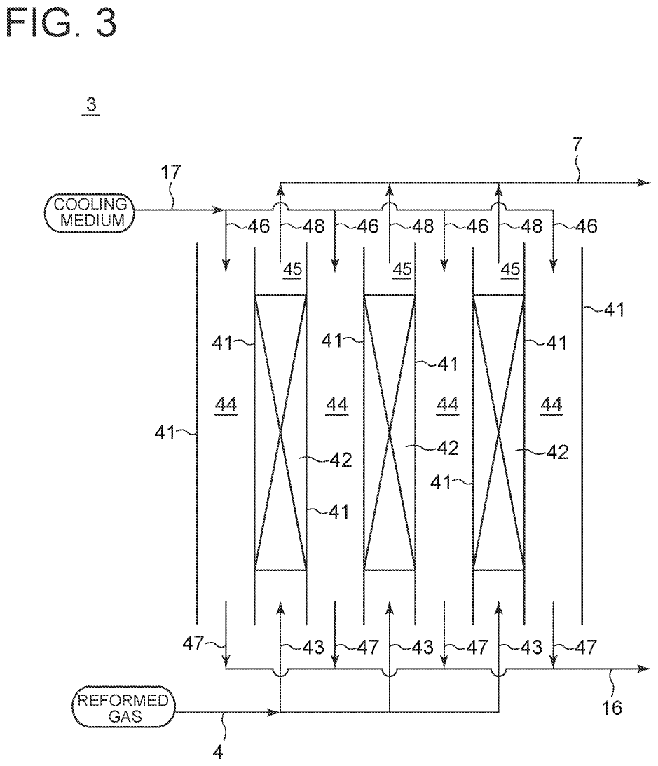

Although a configuration of the methanol synthesis apparatus 3 is not limited particularly, since a methanol synthesis catalyst is also accommodated in the methanol synthesis apparatus 3, the methanol synthesis apparatus 3 may have the same configuration as the plate-type heat exchanger similarly to the reforming device 2. As illustrated in FIG. 3, the methanol synthesis apparatus 3 of this configuration has a plurality of (three or more) plates 41 arranged in parallel. A reformed gas circulation chamber 45 in which the methanol synthesis catalyst 42 is accommodated and a reformed gas circulates and a cooling medium circulation chamber 44 in which a cooling medium circulates are provided in the methanol synthesis apparatus 3 so as to be arranged alternately in the direction in which the plurality of plates 41 are arranged in parallel. Cooling medium supply pipes 46 branched off from the cooling medium circulation pipe 17 and a heating medium outlet pipe 47 through which a heating medium generated when a cooling medium is heated by the operation to be described later flows out of the cooling medium circulation chambers 44 communicate with the cooling medium circulation chambers 44. The heating medium outlet pipes 47 are connected to the heating medium circulation pipe 16. Reformed gas supply pipes 43 branched off from the pipe 4 and an out-flowing fluid outlet pipe 48 through which the out-flowing fluid from the reformed gas circulation chambers 45 flows out communicate with the reformed gas circulation chambers 45. The out-flowing fluid outlet pipes 48 are connected to the pipe 7.

However, the configuration of the methanol synthesis apparatus 3 is not limited to the same configuration as the plate-type heat exchanger, but an arbitrary configuration such as a cylindrical structure disclosed in Japanese Patent No. 6312494 may be employed. Moreover, the methanol synthesis catalyst 42 is not limited particularly, and an arbitrary methanol synthesis catalyst can be used.

<Configuration of Devices Other than Reforming Device 2 and Methanol Synthesis Apparatus 3>

The other devices provided in the plant 1, that is, the heat exchangers 5 and 9, the compressors 6 and 13, the distillation device 8, and the gas-liquid separation device 10, are not limited particularly to those configurations, and devices having arbitrary configurations can be used.

<Operation of Plant 1 According to Embodiment 1>

Next, an operation of the plant according to Embodiment 1 of the present disclosure will be described. As illustrated in FIG. 1, a source gas at least including carbon dioxide and methane and steam for the steam reforming are supplied to the reforming device 2. As described above, in the reforming device 2, the source gas is reformed by steam reforming described by reaction formula (1) and dry reforming described by reaction formula (2). Since both reactions are endothermic reactions, it is necessary to apply heat to the reforming device 2 in order to continue both reactions. Due to this, a heating medium is supplied to the heating medium circulation chamber 14.

As illustrated in FIG. 2, the source gas is supplied to the source gas circulation chambers 25 through the source gas supply pipes 23. The steam for the steam reforming is also supplied to the source gas circulation chambers 25 through the source gas supply pipes 23. The heating medium is supplied to the heating medium circulation chambers 14 through the heating medium supply pipes 24. The source gas circulating in the source gas circulation chambers 25 and the heating medium including exhaust heat circulating in the heating medium circulation chambers 14 exchange heat through the plates 21. At this time, by adjusting the supply amount of the heat medium to the heating medium circulation chambers 14, the temperature in the source gas circulation chambers 25 is adjusted to a temperature appropriate for the reactions described by the reaction formulas (1) and (2).

In this case, when the electric power supply member 30 is operated, a current flows from the DC power supply 31 sequentially to the wire 32, the branch wires 32a, the plates 21 to which the branch wires 32a are connected, the reforming catalyst 22, the plates 21 to which the branch wires 33a of the wire 33 are connected, the branch wires 33a, and the wire 33. In this way, since the reforming catalyst 22 causes a reforming reaction to take place in a state in which a current flows therethrough (that is, an electric power is supplied thereto), the reforming catalyst 22 is an electric field catalyst.

When an electric field catalyst is used as a catalyst for a reforming reaction, active species are generated electrochemically on the surface of the catalyst whereby a target product is generated via an intermediate material in a transition state different from that of a normal thermal catalyst. Therefore, the activation energy is lower than that when a normal thermal catalyst was used, and a target product can be obtained at a low temperature. When this is applied to the reactions described by the reaction formulas (1) and (2) of Embodiment 1, although a temperature of approximately 900° C. is required to cause these reactions to take place when a normal thermal catalyst is used, these reactions take place at a temperature lower than 900° C. when such an electric field catalyst is used. Therefore, it is possible to decrease the temperature of the heating medium supplied to the heating medium circulation chamber 14 as compared to when a normal thermal catalyst is used, and a choice range of a heating medium widens.

An appropriate temperature range of these reactions when an electric field catalyst is used is from 373 to 700 [K]. Since the pressure in the reforming device 2 is generally one atm or more, when steam is used as a heating medium at one atm, 373 [K] which is the temperature at which steam does not condense is the lower limit. However, since the boiling point of water increases as the pressure in the reforming device 2 (that is, the pressure of steam) increases, the lower limit of the temperature range can be said to be the boiling point of water corresponding to the pressure in the reforming device 2. On the other hand, the upper limit of the temperature range is set to 700 [K] since the temperature at which reverse reactions of these reactions start taking place is approximately 700 [K]. As described above, although the reaction formulas (1) and (2) are equilibrium reactions in which a forward reaction and a reverse reaction occur simultaneously, when these reactions are caused to occur using an electric field catalyst, a reverse reaction does not occur but a forward reaction only occurs while the temperature is low (that is, 700 [K] or lower). A high conversion rate can be obtained if only the forward reaction occurs. Therefore, the upper limit of the temperature range is set to 700 [K].

While the source gas and the steam circulate through the source gas circulation chambers 25, the source gas becomes a reformed gas including at least a carbon monoxide and hydrogen by the steam reforming and the dry reforming using the reforming catalyst 22. The reformed gas flowing out of the source gas circulation chambers 25 flows into the pipe 4 through the reformed gas outlet pipes 26. On the other hand, a heating medium heat-exchanged with the source gas and the reformed gas in the source gas circulation chambers 25 while circulating through the heating medium circulation chambers 14 is cooled to become a cooling medium which flows out of the heating medium circulation chambers 14 through the cooling medium outlet pipes 27 to flow into the cooling medium circulation pipe 17.

As illustrated in FIG. 1, the reformed gas flowing out of the reforming device 2 to circulate through the pipe 4 is cooled by the heat exchanger 5 and compressed by the compressor 6 to flow into the methanol synthesis apparatus 3. On the other hand, the cooling medium flowing out of the heating medium circulation chambers 14 to circulate through the cooling medium circulation pipe 17 is supplied to the cooling medium circulation chamber 15 of the methanol synthesis apparatus 3.

As illustrated in FIG. 3, the reformed gas circulating through the pipe 4 is supplied to the reformed gas circulation chambers 45 through the reformed gas supply pipes 43. The cooling medium circulating through the cooling medium circulation pipe 17 is supplied to the cooling medium circulation chambers 44 through the cooling medium supply pipes 46. While the reformed gas is circulating through the reformed gas supply pipes 43, a methanol synthesis reaction occurs due to the methanol synthesis catalyst 42 and methanol is synthesized from the reformed gas. Since a methanol synthesis reaction is an exothermic reaction, the cooling medium circulating through the cooling medium circulation chambers 44 exchanges heat with the plates 41, whereby the temperature in the reformed gas circulation chambers 45 is adjusted to a temperature appropriate to the methanol synthesis reaction.

An out-flowing fluid including methanol flows out of the reformed gas circulation chambers 45 through the out-flowing fluid outlet pipes 48, and the out-flowing fluid flows into the pipe 7. On the other hand, a cooling medium heat-exchanged with the reformed gas and methanol in the reformed gas circulation chambers 45 while circulating through the cooling medium circulation chambers 44 is heated to become a heating medium, which flows out of the cooling medium circulation chambers 44 through the heating medium outlet pipes 47 and flows into the heating medium circulation pipe 16.

As illustrated in FIG. 1, an out-flowing fluid flowing out of the methanol synthesis apparatus 3 to circulate through the pipe 7 is cooled by the heat exchanger 9 and flows into the gas-liquid separation device 10. The out-flowing fluid in the gas-liquid separation device 10 is separated into a gas component and a liquid component, and the liquid component is supplied to the distillation device and a methanol concentration is increased by distillation. On the other hand, the gas component flows into the recycle line 12 and is compressed by the compressor 13 and is supplied to the methanol synthesis apparatus 3 as a raw material. Since there is a possibility that the gas component contains a portion of the component in the reformed gas which was not used for synthesis of methanol in the methanol synthesis apparatus 3, the gas component can be reused as a raw material. A remaining gas component is processed as an off-gas through the off-gas line 11.

In the above-description, although specific types of the heating medium and the cooling medium are not specified, steam can be used as the heating medium, for example. In this case, the cooling medium is pressurized water. As described above, when an electric field catalyst is used in the reforming device 2, since the reaction temperature of the steam reforming and the dry reforming can be decreased, a choice range of a heating medium widens. In general, in a factory, since the lower the temperature of steam, the more abundant the steam, the utilization balance of steam in a factory can be improved.

Since the reaction temperature of the steam reforming and the dry reforming decreases as compared to using a normal thermal catalyst as the reforming catalyst 22, it is possible to adjust the reaction temperature of the reforming reaction of the source gas in the reforming device 2 using the steam including the exhaust heat generated due to consumption of the reformed gas in the methanol synthesis apparatus 3 (that is, the steam including the reaction heat of the methanol synthesis reaction). Specifically, when steam is supplied to the heating medium circulation chamber 14 of the reforming device 2, the steam is cooled to become pressurized water by exchanging heat with the source gas in the reforming device 2. The pressurized water flows out of the heating medium circulation chamber 14 as a cooling medium and circulates through the cooling medium circulation pipe 17 and flows into the cooling medium circulation chamber 15 of the methanol synthesis apparatus 3. In the methanol synthesis apparatus 3, the pressurized water exchanges heat with the reformed gas (that is, the pressurized water is heated with the reaction heat of the methanol synthesis reaction) to become steam. This steam flows out of the cooling medium circulation chamber 15 as a heating medium and circulates through the heating medium circulation pipe 16 and is supplied again to the heating medium circulation chamber 14.

In this way, since the reforming catalyst 22 is an electric field catalyst that supplies electric power to the reforming catalyst 22 to reform the source gas, it is possible to decrease the reaction temperature of the reforming reaction of the source gas as compared to not using the electric field catalyst. As a result, since it is possible to adjust the reaction temperature of the reforming reaction of the source gas in the reforming device 2 using the steam including the exhaust heat due to consumption of the reformed gas in the methanol synthesis apparatus 3 (that is, the steam including the reaction heat of the methanol synthesis reaction), it is possible to suppress increase in the cost of the plant 1 that consumes the reformed gas.

In Embodiment 1, reforming of the raw material in the reforming device 2 is performed by simultaneously performing dry reforming and steam reforming. In this way, a reformed gas of which the M value (=[H₂]/(2[CO]+3[CO₂])) is approximately 1 is obtained. Since a reformed gas having the M value of 1 is appropriate for synthesis of methanol, it is possible to increase the efficiency of methanol synthesis.

As described above, in Embodiment 1, since a high conversion rate can be obtained as compared to using a normal thermal catalyst when an electric field catalyst is used as the reforming catalyst 22, the amount of consumption of carbon dioxide in the raw material in the reforming device 2 also increases. Therefore, a portion of the carbon dioxide may be received from the outside of the plant 1. With this configuration, it is possible to obtain an advantage by receiving carbon dioxide.

### Modification of Embodiment 1

In Embodiment 1, only the steam (first steam) generated by being heated by the reaction heat of the methanol synthesis reaction in the methanol synthesis apparatus 3 is used as the heating medium. However, in this embodiment, the temperature of the first steam may vary according to the progress state of the synthesis reaction of methanol. When the temperature of the first steam varies, the amount of heat necessary for the reforming reaction may be insufficient with the first steam only. In this case, it may be unable to appropriately adjust the temperature of the reforming reaction with the first steam only.

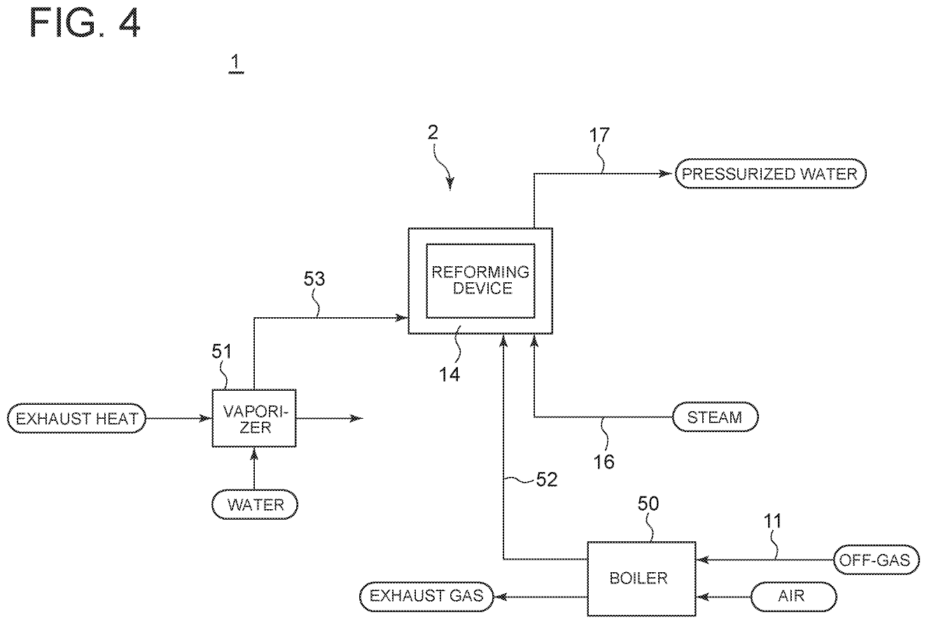

As illustrated in FIG. 4, in the plant 1 according to a modification of Embodiment 1 of the present disclosure, a second steam supply pipe 52 for supplying steam (second steam) generated by combusting the off-gas having circulated through the off-gas line 11 and air in the boiler 50 and a third steam supply pipe 53 for supplying steam (third steam) generated in the vaporizer 51 by the exhaust heat generated outside the plant 1 are connected to the heating medium circulation chamber 14 of the reforming device 2 as well as the heating medium circulation pipe 16. In this case, the heating medium includes the first steam having circulated through the heating medium circulation pipe 16 and added steam different from the first steam (that is, the second steam having circulated through the second steam supply pipe 52 and the third steam having circulated through the third steam supply pipe 53).

According to this configuration, even when the temperature of the first steam having circulated through the heating medium circulation pipe 16 varies, it is possible to adjust the reaction temperature of the reforming reaction appropriately by adjusting the supply amount of the added steam (that is, the second and third steam). There is no limitation to adjusting the reaction temperature of the reforming reaction using the first, second, and third steam, but the reaction temperature of the reforming reaction may be adjusted using the first and second steam or the first and third steam. Moreover, the supply source of the added steam is not limited to the boiler 50 and the vaporizer 51, and these are examples only. Moreover, the number of supply sources of the added steam is not limited to two sources as in the above example, but the added steam may be supplied from one source and the added steam may be supplied from three or more sources.

### Embodiment 2

Next, a plant according to Embodiment 2 will be described. The plant according to Embodiment 2 is configured such that the reformed gas consuming apparatus in Embodiment 1 is changed to a device that consumes fuel to generate electric power. In Embodiment 2, the same components as those of Embodiment 1 will be denoted by the same reference numerals, and the detailed description thereof will be omitted.

<Configuration of Plant 1 According to Embodiment 2>

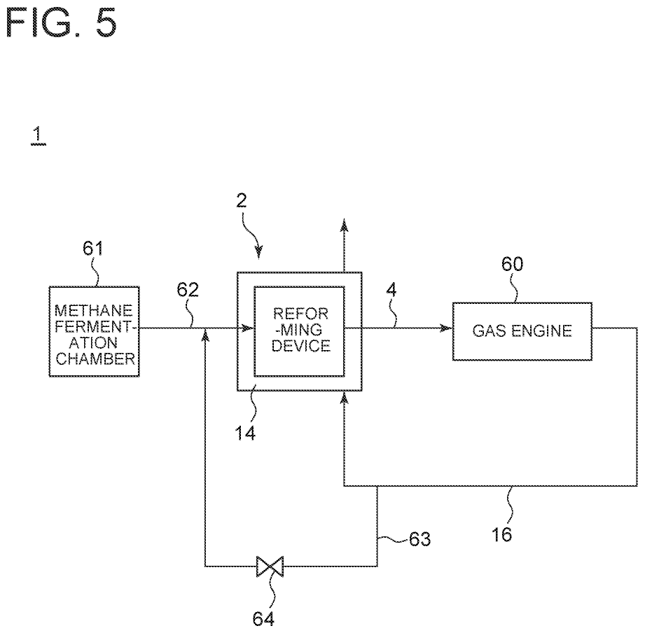

As illustrated in FIG. 5, the plant 1 according to Embodiment 2 of the present disclosure includes a reforming device 2 that reforms a source gas including at least methane and carbon dioxide and a gas engine 60 which is a reformed gas consuming apparatus that consumes the reformed gas obtained by the reforming device 2 as a fuel. That is, the gas engine 60 corresponds to a device that consumes fuel to generate electric power. The configuration of the reforming device 2 is basically the same as the configuration of the reforming device 2 provided in the plant 1 of Embodiment 1. However, since the reforming device 2 of Embodiment 2 reforms a source gas by dry reforming only, Embodiment 2 is different from Embodiment 1 in that steam is not supplied to the reforming device 2 and the reforming catalyst 22 is made up of a catalyst for dry reforming only.

The reforming device 2 and the gas engine 60 are connected by a pipe 4 for supplying the reformed gas obtained by the reforming device 2 to the gas engine 60. Moreover, the gas engine 60 and the heating medium circulation chamber 14 are connected by the heating medium circulation pipe 16 so that the exhaust gas of the gas engine 60 generated due to consumption of the reformed gas can be supplied to the heating medium circulation chamber 14 of the reforming device 2 as a heating medium.

Although not particularly limited in Embodiment 2, the plant 1 may include a methane fermentation chamber 61 as a source gas supply source. The methane fermentation chamber 61 and the reforming device 2 are connected by the pipe 62. When the plant 1 includes the methane fermentation chamber 61 as the source gas supply source, the source gas supplied to the reforming device 2 is a digestion gas including methane and carbon dioxide.

Although it is not an essential configuration to Embodiment 2, a branch pipe 63 having one end branching off from the heating medium circulation pipe 16 and the other end connected to the pipe 62 may be provided so that a portion of the exhaust gas exhausted from the gas engine 60 can be supplied to the reforming device 2 as a raw material of the reforming reaction of the source gas. An exhaust gas flow regulating valve 64 for adjusting the flow rate of the exhaust gas to be supplied to the reforming device 2 may be provided in the branch pipe 63.

<Operation of Plant 1 According to Embodiment 2>

Next, an operation of the plant according to Embodiment 2 of the present disclosure will be described. As illustrated in FIG. 5, a digestion gas generated by the methane fermentation chamber 61 is supplied to the reforming device 2 through the pipe 62 as a source gas. The operation of the reforming device 2 is different from that of the reforming device 2 of Embodiment 1 in that the source gas is reformed by dry reforming only to generate a reformed gas.

The reformed gas generated by the reforming device 2 is supplied to the gas engine 60 through the pipe 4. The gas engine 60 is driven using the reformed gas as a fuel. In the gas engine 60, an exhaust gas is generated when the reformed gas is consumed as fuel, and the exhaust gas flows out of the gas engine 60 and circulates through the heating medium circulation pipe 16. The exhaust gas includes the exhaust heat generated due to consumption of the reformed gas as fuel in the gas engine 60.

As illustrated in FIG. 2, the source gas becomes a reformed gas including at least a carbon monoxide and hydrogen by dry reforming of the reforming catalyst 22 which is an electric field catalyst while the source gas is circulating through the source gas circulation chambers 25, and the exhaust gas which is a heating medium is supplied to the heating medium circulation chambers 14, and the source gas circulating through the source gas circulation chambers 25 and the exhaust gas circulating through the heating medium circulation chambers 14 exchange each through the plates 21 whereby the temperature in the source gas circulation chambers 25 is adjusted to a temperature appropriate for the dry reforming, which is the same as the operation of the reforming device 2 of Embodiment 1. However, as illustrated in FIG. 5, the exhaust gas flowing out of the heating medium circulation chambers 14 is not returned to the gas engine 60, which is different from the operation of Embodiment 1.

In Embodiment 2, since the reforming catalyst 22 is an electric field catalyst similarly to Embodiment 1, it is possible to decrease the reaction temperature of the reforming reaction of the source gas as compare to not using the electric field catalyst. As a result, since it is possible to adjust the reaction temperature of the reforming reaction of the source gas in the reforming device 2 using the exhaust gas including the exhaust heat due to consumption of the reformed gas in the gas engine 60, it is possible to suppress increase in the cost of the plant 1 that consumes the reformed gas.

In Embodiment 2, when the branch pipe 63 and the exhaust gas flow regulating valve 64 are provided, a portion of the exhaust gas exhausted from the gas engine 60 can be supplied to the reforming device 2 as a raw material of the reforming reaction of the source gas. The exhaust gas of the gas engine 60 includes moisture, carbon dioxide, and oxygen. Therefore, when the exhaust gas of the gas engine 60 is supplied to the reforming device 2, since moisture, carbon dioxide, and oxygen are supplied to the reforming device 2, it is possible to increase reforming efficiency. Moreover, heat can be supplied to reforming of carbon dioxide by temperature rise as sensible heat and heat generation of a partial oxidation reaction of oxygen.

In Embodiment 2, the reforming device 2 reforms a source gas using dry reforming only. However, dry reforming and steam reforming may be performed simultaneously similarly to Embodiment 1. When the digestion gas generated by the methane fermentation chamber 61 is used as a source gas, since the digestion gas originates from animals and plants, the percentages of methane and carbon dioxide are 60% and 40%, respectively, and it is not possible to reform methane completely even when the entire carbon dioxide is used. Since the digestion gas includes moisture at a saturated steam pressure (10 to 15% at normal pressure) at the temperature (approximately about 50° C.) at the outlet of the methane fermentation chamber 61, by performing steam reforming simultaneously without separating condensed water, reforming of methane can be progressed further (the conversion rate of methane can be increased). As a result, it is possible to increase the amount of heat generated by the source gas.

### Embodiment 3

Next, a plant according to Embodiment 3 will be described. The plant according to Embodiment 3 is configured such that the reformed gas consuming apparatus in Embodiment 1 is changed to a device that consumes fuel to generate electric power. In Embodiment 3, the same components as those of Embodiment 1 will be denoted by the same reference numerals, and the detailed description thereof will be omitted.

<Configuration of Plant 1 According to Embodiment 3>

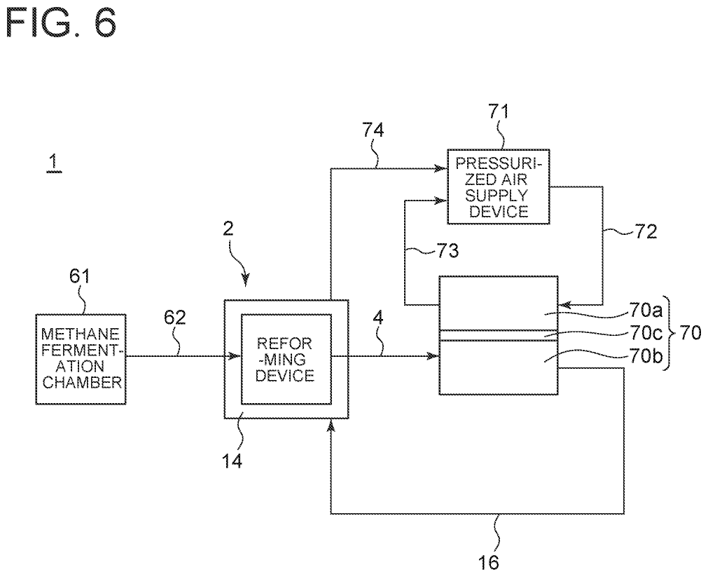

As illustrated in FIG. 6, a plant 1 according to Embodiment 3 of the present disclosure includes a reforming device 2 that reforms a source gas including at least methane and carbon dioxide and a solid oxide fuel cell (SOFC) 70 which is a reformed gas consuming apparatus that consumes the reformed gas obtained by the reforming device 2 as a fuel. That is, the SOFC 70 corresponds to a device that consumes a fuel to generate electric power. A configuration of the reforming device 2 is the same as the configuration of the reforming device 2 provided in the plant 1 of Embodiment 1.

The SOFC 70 includes an air electrode 70a, a fuel electrode 70b, and a solid electrolyte 70c provided between the air electrode 70a and the fuel electrode 70b. A pressurized air supply device 71 for supplying a pressurized air is provided in the air electrode 70a, and the air electrode 70a and the pressurized air supply device 71 communicate with each other through a pressurized air supply pipe 72 in which pressurized air flowing out of the pressurized air supply device 71 circulates and an exhaust air circulation pipe 73 in which exhaust air flowing out of the air electrode 70a circulates. The fuel electrode 70b communicates with the reforming device 2 through the pipe 4. The fuel electrode 70b and the heating medium circulation chamber 14 are connected by the heating medium circulation pipe 16 so that the exhaust gas (that is, exhaust fuel) flowing out of the fuel electrode 70b can be supplied to the heating medium circulation chamber 14 of the reforming device 2. The heating medium circulation chamber 14 and the pressurized air supply device 71 are connected by the pipe 74 so that the exhaust fuel flowing out of the heating medium circulation chamber 14 can be supplied to the pressurized air supply device 71. The other configuration is the same as that of Embodiment 1.

<Operation of Plant 1 According to Embodiment 3>

Next, an operation of the plant according to Embodiment 3 of the present disclosure will be described. As illustrated in FIG. 6, an operation in which the digestion gas generated by the methane fermentation chamber 61 is supplied to the reforming device 2 through the pipe 62 as a source gas to generate a reformed gas is the same as that of Embodiment 1. However, a heating medium supplied to the heating medium circulation chamber 14 of the reforming device 2 is the exhaust fuel flowing out of the fuel electrode 70b of the SOFC 70 by the operation to be described later, which is different from that of Embodiment 1.

The reformed gas generated by the reforming device 2 is supplied to the fuel electrode 70b of the SOFC 70 through the pipe 4. A pressurized air is supplied from the pressurized air supply device 71 to the air electrode 70a of the SOFC 70 through the pressurized air supply pipe 72. In the SOFC 70, oxygen in the pressurized air circulating through the air electrode 70a, hydrogen and a carbon monoxide in the reformed gas circulating through the fuel electrode 70b react with each other through the solid electrolyte 70c to generate electricity. The reaction heat of this reaction includes an exhaust fuel flowing out of the fuel electrode 70b. Therefore, the exhaust fuel flows out of the fuel electrode 70b and is supplied to the heating medium circulation chamber 14 of the reforming device 2 through the heating medium circulation pipe 16 as a heating medium. The operation of the exhaust fuel in the reforming device 2 as a heating medium is the same as that of Embodiment 2. The exhaust fuel flowing out of the heating medium circulation chamber 14 is supplied to the pressurized air supply device 71 as the pipe 74 and can be used as a fuel for manufacturing the pressurized air. On the other hand, the exhaust air flowing out of the air electrode 70a returns to the pressurized air supply device 71 through the exhaust air circulation pipe 73.

In Embodiment 3, similarly to Embodiments 1 and 2, since the reforming catalyst 22 (see FIG. 2) is an electric field catalyst, it is possible to decrease the reaction temperature of the reforming reaction of the source gas as compare to not using the electric field catalyst. As a result, since it is possible to adjust the reaction temperature of the reforming reaction of the source gas in the reforming device 2 using the exhaust gas including the exhaust heat due to consumption of the reformed gas in the SOFC 70, it is possible to suppress increase in the cost of the plant 1 that consumes the reformed gas.

In Embodiment 3, although the heating medium was an exhaust fuel flowing out of the fuel electrode 70b of the SOFC 70, the exhaust air flowing out of the air electrode 70a may be used as the heating medium. That is, either one of the exhaust fuel and the exhaust air which are the exhaust gas flowing out of the SOFC 70 may be used as the heating medium. Since the amount of gas of the exhaust air is larger than the amount of gas of the exhaust fuel, the exhaust air can be used effectively as the heating medium. On the other hand, non-used fuel remains in the exhaust fuel, the exhaust fuel may be mixed with the exhaust air so as to be used for combustion in the SOFC 70. In this case, since the exhaust air cannot be used as a heating medium, the exhaust fuel is used as a heating medium.

The contents described in the respective embodiments can be grasped as follows, for example.

(1) A plant according to an aspect is a plant (1) that consumes a reformed gas obtained by reforming a source gas including at least methane and carbon dioxide, and includes: a reforming device (2) that includes a reforming catalyst (22) for reforming the source gas and an electric power supply member (30) for supplying electric power to the reforming catalyst (22) and that supplies electric power to the reforming catalyst (22) to reform the source gas; and a reformed gas consuming apparatus (a methanol synthesis apparatus 3, a gas engine 60, or a solid oxide fuel cell 70) that consumes the reformed gas A reaction temperature of a reforming reaction of the source gas in the reforming device can be adjusted by adjusting a supply amount of a heating medium, including exhaust heat generated due to consumption of the reformed gas in the reformed gas consuming apparatus, to the reforming device (2) when heat exchange between the source gas and the heat medium is performed in the reforming gas (2).

According to the plant of the present disclosure, since a reforming catalyst is an electric field catalyst that supplies electric power to a reforming catalyst to reform a source gas, it is possible to decrease a reaction temperature of a reforming reaction of the source gas as compared to when an electric field catalyst is not used. As a result, since a reaction temperature of the reforming reaction of the source gas in the reforming device can be adjusted using a heating medium including the exhaust heat generated due to consumption of the reformed gas in the reformed gas consuming apparatus, it is possible to suppress increase in the cost of a plant that consumes the reformed gas.

(2) A plant according to another aspect is the plant according to (1), wherein the reformed gas consuming apparatus is a methanol synthesis apparatus (3) in which the reformed gas is consumed as a raw material of synthesis of a methanol, and the reforming reaction of the source gas includes both: steam reforming in which methane and a steam react with each other; and dry reforming in which methane and carbon dioxide react with each other.

According to this configuration, by simultaneously performing steam reforming and dry reforming, a reformed gas of which the M value (=[H₂]/(2[CO]+3[CO₂])) is approximately 1 is obtained. Since a reformed gas having the M value of 1 is appropriate for synthesis of methanol, it is possible to increase the efficiency of methanol synthesis.

(3) A plant according to still another aspect is the plant according to (2), wherein the heating medium includes: a first steam generated by a reaction heat of the synthesis reaction of the methanol; and an added steam different from the first steam.

The temperature of the first steam generated by the reaction heat of the methanol synthesis reaction varies according to the progress state of the methanol synthesis reaction, and it may be unable to adjust the temperature of the reforming reaction appropriately. However, according to this configuration, even when the temperature of the first steam varies, it is possible to adjust the reaction temperature of the reforming reaction by adjusting the supply amount of the added steam.

(4) A plant according to still another aspect is the plant according to (3), further including: a boiler (50), wherein the added steam includes a second steam generated by the boiler (50).

According to this configuration, even when the temperature of the first steam varies, it is possible to adjust the reaction temperature of the reforming reaction by adjusting the supply amount of the second steam.

(5) A plant according to still another aspect is the plant according to (3) or (4), further including: a vaporizer (51), wherein the added steam includes a third steam generated by the vaporizer (51).

According to this configuration, even when the temperature of the first steam varies, it is possible to adjust the reaction temperature of the reforming reaction by adjusting the supply amount of the third steam.

(6) A plant according to still another aspect is the plant according to (1), wherein the reformed gas consuming apparatus is a device (a gas engine 60 or a solid oxide fuel cell 70) that produces electric power by consuming a fuel, and the heating medium includes an exhaust gas exhausted from the device (60 or 70).

According to this configuration, since the reforming catalyst is an electric field catalyst, it is possible to decrease the reaction temperature of the reforming reaction of the source gas as compare to not using the electric field catalyst. As a result, since it is possible to adjust the reaction temperature of the reforming reaction of the source gas in the reforming device using the exhaust gas generated due to consumption of the reformed gas in the device that produces electric power by consuming a fuel, it is possible to suppress increase in the cost of a plant in which the reformed gas is consumed by the device that produces electric power by consuming a fuel.

(7) A plant according to still another aspect is the plant according to (6), wherein the device is a gas engine (60).

According to this configuration, since the reforming catalyst is an electric field catalyst, it is possible to decrease the reaction temperature of the reforming reaction of the source gas as compare to not using the electric field catalyst. As a result, since it is possible to adjust the reaction temperature of the reforming reaction of the source gas in the reforming device using the exhaust gas generated due to consumption of the reformed gas in the gas engine, it is possible to suppress increase in the cost of a plant in which the reformed gas is consumed by the gas engine.

(8) A plant according to still another aspect is the plant according to (7), wherein a portion of the exhaust gas of the gas engine (60) is supplied to the reforming device (2) as a raw material of the reforming reaction of the source gas.

The exhaust gas of the gas engine includes moisture, carbon dioxide, and oxygen. Therefore, according to this configuration, when the exhaust gas of the gas engine is supplied to the reforming device as a raw material of the reforming reaction of the source gas, since moisture, carbon dioxide, and oxygen are supplied to the reforming device, it is possible to increase the reforming efficiency. Moreover, heat can be supplied to reforming of carbon dioxide by temperature rise as sensible heat and heat generation of a partial oxidation reaction of oxygen.

(9) A plant according to still another aspect is the plant according to (7) or (8), wherein the reforming reaction of the source gas includes both: steam reforming in which methane and a steam react with each other; and dry reforming in which methane and carbon dioxide react with each other.

When the digestion gas generated by the methane fermentation chamber is used as a source gas, since the digestion gas originates from animals and plants, the percentages of methane and carbon dioxide are 60% and 40%, respectively, and it is not possible to reform methane completely even when the entire carbon dioxide is used. In contrast, according to the configuration of (9), since the digestion gas includes moisture at a saturated steam pressure (10 to 15% at normal pressure) at the temperature (approximately about 50° C.) at the outlet of the methane fermentation chamber, by performing steam reforming simultaneously without separating condensed water, reforming of methane can be progressed further (the conversion rate of methane can be increased). As a result, it is possible to increase the amount of heat generated by the source gas.

(10) A plant according to still another aspect is the plant according to (6), wherein the device is a solid oxide fuel cell.

According to this configuration, since the reforming catalyst is an electric field catalyst, it is possible to decrease the reaction temperature of the reforming reaction of the source gas as compare to not using the electric field catalyst. As a result, since it is possible to adjust the reaction temperature of the reforming reaction of the source gas in the reforming device using the exhaust gas generated due to consumption of the reformed gas in the solid oxide fuel cell, it is possible to suppress increase in the cost of a plant in which the reformed gas is consumed by the solid oxide fuel cell.

(11) A plant according to still another aspect is the plant according to any one of (1) to (10), wherein a portion of the carbon dioxide is received from outside the plant (1).

Since a high conversion rate can be obtained as compared to using a normal thermal catalyst when an electric field catalyst is used as the reforming catalyst, the amount of consumption of carbon dioxide in the raw material in the reforming device also increases. Therefore, a portion of the carbon dioxide may be received from the outside of the plant, and it is possible to obtain an advantage by receiving carbon dioxide.

(12) A plant according to still another aspect is the plant according to any one of (1) to (11), wherein a reaction temperature of the reforming reaction of the source gas is in the range from 373K to 700K.

If the pressure in the reforming device is one atm, when the temperature is set to 373K or higher, since the steam supplied to the reforming device does not liquefied, a dry reforming reaction can be continued. Moreover, when an electric field catalyst is used, since reverse reactions of the steam reforming and dry reforming reactions do not occur at a temperature of 700K or lower, it is possible to obtain a high conversion rate at a low temperature as compare to not using the electric field catalyst.

(13) A plant according to still another aspect is the plant according to any one of (1) to (12), wherein the reforming device (2) includes at least three plates (21) arranged in parallel, a source gas circulation chamber (25) in which the source gas circulates and a heating medium circulation chamber (14) in which the heating medium circulates are formed between adjacent plates (21, 21) so as to be arranged alternately in a direction in which the plates (21) are arranged in parallel, the reforming catalyst (22) is accommodated in the source gas circulation chamber (25), and the electric power supply member (30) supplies electric power to the plates (21).

According to this configuration, it is possible to reform the source gas using an electric field catalyst in the reforming device.

(14) A method according to an aspect is a method for reforming a source gas including at least methane and carbon dioxide, including: a reforming step of reforming the source gas by supplying electric power to a reforming catalyst for reforming the source gas; a consuming step of consuming the reformed gas; and an adjusting step of adjusting a reaction temperature of a reforming reaction of the source gas in the reforming step by adjusting a supply amount of a heating medium, including exhaust heat generated due to consumption of the reformed gas, when heat exchange between the source gas and the heat medium is performed.

According to the method, since a reforming catalyst is an electric field catalyst that supplies electric power to a reforming catalyst to reform a source gas, it is possible to decrease a reaction temperature of a reforming reaction of the source gas as compared to when an electric field catalyst is not used. As a result, since a reaction temperature of the reforming reaction of the source gas in the reforming device can be adjusted using a heating medium including the exhaust heat generated due to consumption of the reformed gas in the reformed gas consuming apparatus, it is possible to suppress increase in the cost of a plant that consumes the reformed gas.

1. A plant that consumes a reformed gas obtained by reforming a source gas including at least methane and carbon dioxide, the plant comprising:
a reforming device including a reforming catalyst for reforming the source gas and an electric power supply member for supplying electric power to the reforming catalyst, the reforming device being configured to supply electric power to the reforming catalyst to reform the source gas; and
a reformed gas consuming apparatus configured to consume the reformed gas, wherein
a reaction temperature of a reforming reaction of the source gas in the reforming device is adjustable by adjusting a supply amount of a heating medium to the reforming device when heat exchange between the source gas and the heat medium is performed in the reforming gas, the heat medium including exhaust heat generated due to consumption of the reformed gas in the reformed gas consuming apparatus.

2. The plant according to claim 1, wherein
the reformed gas consuming apparatus is a methanol synthesis apparatus in which the reformed gas is consumed as a raw material of synthesis of a methanol, and
the reforming reaction of the source gas includes both:
steam reforming in which methane and a steam react with each other; and
dry reforming in which methane and carbon dioxide react with each other.

3. The plant according to claim 2, wherein
the heating medium includes:
a first steam generated by a reaction heat of the synthesis reaction of the methanol; and
an added steam different from the first steam.

4. The plant according to claim 3, further comprising:
a boiler, wherein
the added steam includes a second steam generated by the boiler.

5. The plant according to claim 3, further comprising:
a vaporizer, wherein
the added steam includes a third steam generated by the vaporizer.

6. The plant according to claim 1, wherein
the reformed gas consuming apparatus is a device configured to produce electric power by consuming a fuel, and
the heating medium includes an exhaust gas exhausted from the device.

7. The plant according to claim 6, wherein
the device is a gas engine.

8. The plant according to claim 7, wherein
a portion of the exhaust gas of the gas engine is supplied to the reforming device as a raw material of the reforming reaction of the source gas.

9. The plant according to claim 7, wherein
the reforming reaction of the source gas includes both:
steam reforming in which methane and a steam react with each other; and
dry reforming in which methane and carbon dioxide react with each other.

10. The plant according to claim 6, wherein
the device is a solid oxide fuel cell.

11. The plant according to claim 1, wherein
a portion of the carbon dioxide is received from outside the plant.

12. The plant according to claim 1, wherein
a reaction temperature of the reforming reaction of the source gas is in a range from 373K to 700K.

13. The plant according to claim 1, wherein
the reforming device includes at least three plates arranged in parallel,
a source gas circulation chamber in which the source gas circulates and a heating medium circulation chamber in which the heating medium circulates are formed between adjacent plates so as to be arranged alternately in a direction in which the plates are arranged in parallel,
the reforming catalyst is accommodated in the source gas circulation chamber, and
the electric power supply member supplies electric power to the plates.

14. A method for reforming a source gas including at least methane and carbon dioxide, the method comprising:
a reforming step of reforming the source gas by supplying electric power to a reforming catalyst for reforming the source gas;
a consuming step of consuming the reformed gas; and
an adjusting step of adjusting a reaction temperature of a reforming reaction of the source gas in the reforming step by adjusting a supply amount of a heating medium when heat exchange between the source gas and the heat medium is performed, the heat medium including exhaust heat generated due to consumption of the reformed gas.
